(19) United States
(12) Patent Application Publication
(10) Pub. No.: US 2007/0228685 A1
(43) Pub. Date: Oct. 4, 2007

(54) Flexure joints for recreational vehicle suspension

(76) Inventor: Jeff Bennett, Roseau, MN (US)

Correspondence Address: BAKER & DANIELS LLP, 300 NORTH MERIDIAN STREET, SUITE 2700, INDIANAPOLIS, IN, 46204, US

(21) Appl. No.: 11/027,856

(22) Filed: Dec. 30, 2004

(51) Int. Cl. B60G 3/20

(52) U.S. Cl. 280/124.135

(57) ABSTRACT

A flexure joint suspension system for use in recreational vehicles such as ATVs. A recreational vehicle having an independent suspension consisting of a flexible material operatively coupling the vehicle chassis to a suspension arm thereby adapting the recreational vehicle for dirt track, rough terrain and general off-highway use, as Well as for running on smooth road surfaces. The flexure joint suspension system may be used in a recreational vehicle of the type used either for utility purposes, such as utility vehicles, or for sports or leisure activities, such as ATVs, snowmobiles, and motorcycles.

### FIELD

The invention relates to vehicle suspensions, and, more particularly, to flexure joint suspension systems on recreational vehicles such as all terrain vehicles (ATVs), snowmobiles, motorcycles, and utility vehicles.

### BACKGROUND

Recreational vehicles designed for off-road and all-terrain use, such as ATVs, snowmobiles, motorcycles, and utility vehicles, which feature propulsion systems, such as internal combustion engines, electric motors and hybrids, are known in the art. Open wheel or “Cart”-type vehicles have used a flexible suspension arm attachment which improves traction over irregular track surfaces. These vehicles employ suspension arm systems which are pivotally mounted to the chassis of the vehicle, allowing movement of the suspension arm system relative to the vehicle chassis.

Current recreational vehicle suspensions, such as those used in ATVs, snowmobiles, motorcycles, and utility vehicles, use rotational-type pivot joints to couple the suspension arms to the chassis of the vehicle. Typically, these rotational-type pivot joints include a ball joint. Vehicle stability and handling may be achieved by providing a fully independent suspension to each of the vehicle's wheels. However, rotational-type pivot joints can be costly because of the number of parts involved. Because of the relative movement between these parts, the joints need to be lubricated to reduce friction, and may require periodic maintenance. Also, because of the environment in which many recreational vehicles are operated, rotational-type pivot joints are often exposed to conditions that make them susceptible to dirt, debris, and corrosion, which creates friction and limits the flexibility of the joint, and can cause premature wear.

Recently, some racecars (such as Indy-style CART racecars) have used flexible members to mount suspension arms as part of their overall suspension system. These vehicles typically operate at very high speeds on relatively flat surfaces.

It is desirable to provide a suspension coupling system for recreational vehicles, such as ATVs, snowmobiles, motorcycles, and utility vehicles, that provides the flexibility required for all terrain use, in a cost effective, easy to maintain manner.

### BRIEF SUMMARY

In an embodiment of the invention, a flexure joint suspension system couples a suspension arm to a chassis of a recreational vehicle, such as an ATV, snowmobile, motorcycle and/or utility vehicle, thereby improving traction and reducing maintenance requirements and costs associated therewith. The flexure joint suspension system may function to isolate the operator from ground irregularities. The flexure joint suspension system can be used to improve this isolation by acting like a damper between the suspension and the chassis.

In a further embodiment of the invention, a flexure joint comprises a body of flexible material adapted to operatively couple a suspension arm to a chassis of a recreational vehicle. The flexure joint can be designed to be compliant such that the suspension geometry can be modified or adjusted. This change in the suspension geometry is called compliance. This compliance can be modified to adjust the ride and handling parameters of the recreational vehicle. Additionally, during an accident or other suspension damaging event, the flexure joint may be adapted to “tear away” from the chassis, potentially saving the chassis from more extensive damage.

In another embodiment of the invention, a method of coupling a suspension arm to a chassis of a recreational vehicle using a flexure joint is disclosed.

### BRIEF DESCRIPTION OF THE DRAWINGS

FIG. 1 is a perspective view of an ATV in which the embodiments of the invention may be incorporated.

FIG. 2 is cross-sectional view of a flexure joint suspension system according to a preferred embodiment of the invention.

FIG. 3 is a perspective view of the flexure joint according to a preferred embodiment of the invention incorporating a bolt-mounting configuration.

FIG. 4 is a cross-sectional view of a flexure joint suspension system according to a preferred embodiment of the invention incorporating a welded configuration.

FIG. 5 is a cross-sectional view of a flexure joint suspension system according to an embodiment of the invention incorporating a single flexure joint suspension arm in conjunction with an optional pivotally mounted suspension arm system.

### DETAILED DESCRIPTION

The following detailed description should be read with reference to the drawings, in which like elements in different drawings are numbered identically. The drawings depict selected embodiments and are not intended to limit the scope of the invention. It will be understood that embodiments shown in the drawings and described below are merely for illustrative purposes, and are not intended to limit the scope of the invention as defined in the claims.

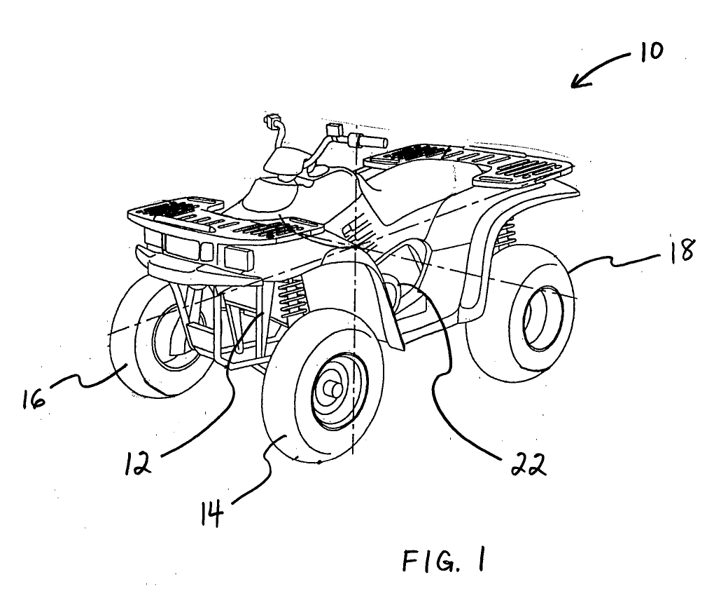

FIG. 1 is a perspective view of an ATV 10. The ATV 10 includes a chassis 12, a left front wheel 14, a right front wheel 16, a left rear wheel 18, and a right rear wheel (not visible in FIG. 1). The ATV 10 also includes an engine 22 that is carried by the chassis 12. The engine 22 is preferably coupled to at least some wheels of the ATV 10 via a drive train for propelling the ATV 10. The engine 22 may be used to power each rear wheel, and in some cases, also each front wheel. Although the invention is herein described and illustrated in the corresponding drawing figures in the context of ATVs, it is to be understood that the invention is not so limited and applies equally in the context of other recreational vehicles, such as utility vehicles, motorcycles, and snowmobiles.

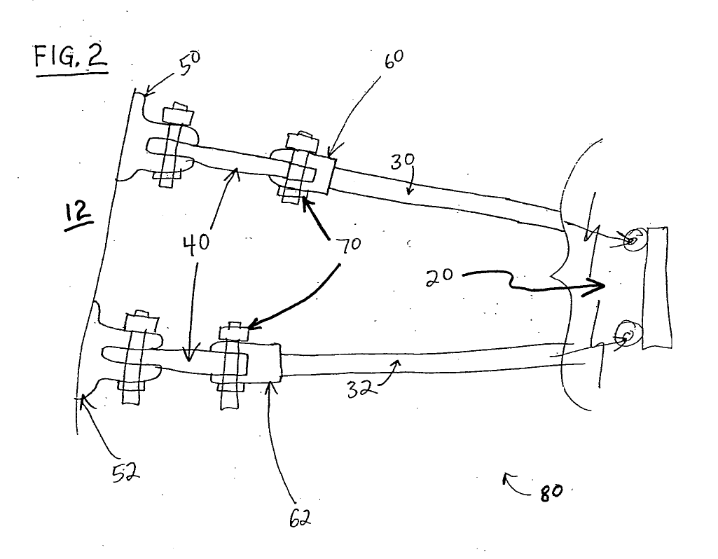

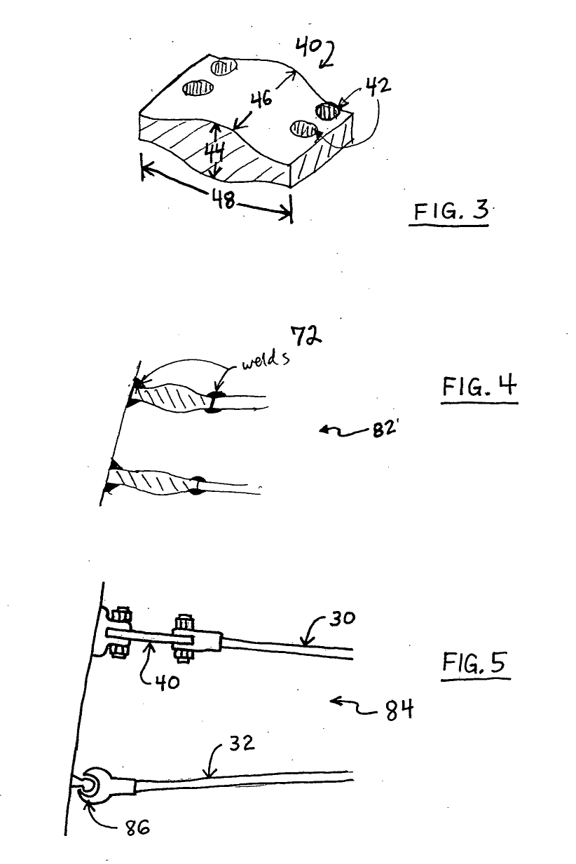

FIG. 2 is cross-sectional view of a flexure joint suspension system 80 according to a preferred embodiment of the invention which may be used in the ATV 10 shown in FIG. 1. While the details of particular embodiments of the invention are described with reference to this particular suspension system 80, it will be understood that variations in the structure and components of the suspension system 80 may be made without departing from the scope of the invention. The suspension system 80 shown in FIG. 2 includes upper and lower suspension arms 30, 32 which may be pivotally mounted to the wheel mount assembly 20, using a ball joint, for example. The upper and lower suspension arms 30, 32 are operatively coupled to the chassis 12 using flexure joints 40 mounted to the chassis by means of upper and lower chassis brackets 50, 52, and mounted to the upper and lower suspension arms 30, 32 by means of upper and lower suspension arm brackets 60, 62, respectively. The flexure joints 40 will be described in greater detail hereinafter with reference to FIG. 3.

Fastening means, such as bolt fasteners 70, may be employed for mounting the flexure joints 40 to the suspension arms 30, 32 and to the chassis 12, as shown in FIG. 2 using conventional bolt fasteners 70 positioned through apertures in the flexure joints 40 and through apertures in each of the chassis and suspension arm brackets 50, 52, 60, 62. Other types of fastening means may be employed to accomplish this purpose without departing from the scope of the invention. For example, the flexure joint 40 may be welded to either the chassis brackets 50, 52 or the suspension arms 30, 32, or both. A clamping mechanism may also be used to mount the flexure joint 40 to the chassis brackets 50, 52 and/or the suspension arms 30, 32, potentially obviating the need for one or more apertures in the flexure joint 40.

FIG. 3 is a perspective view of a flexure joint 40 according to an embodiment of the invention incorporating apertures 42 to support a bolt-mounting configuration. FIG. 3 illustrates an embodiment of the invention in which the thickness 44 and width 46 of the flexure joint 40 is varied over its length 48 to obtain the desired flexibility characteristics. The length 48 of the flexure joint 40 may range from about 0.125 inches to about 24 inches, and may more preferably range from about 3.5 inches to about 6 inches. In an embodiment, the thickness 44 of the flexure joint 40 may range from about 0.10 inches to about 2.5 inches, and may more preferably range from about 0.25 inches to about 0.5 inches, and the width 46 may range from about 0.10 inches to about 24 inches, and may more preferably range from about 2 inches to about 4 inches.

The flexure joint 40, in some embodiments, may be designed to break or “tear away,” for example during an accident or other potentially suspension-damaging event. This feature may prevent further damage to the vehicle chassis, in an accident for example, by allowing the flexure joint 40 to be the point of failure, rather than the chassis 12 or the suspension arms 30, 32. The flexure joint 40 may also be easier and less costly to replace in such an event.

The flexure joint 40 may be composed of any material possessing the desired flexibility characteristics, such as plastic, rubber, a metal such as steel, or a composite material such as fiberglass, carbon fiber, Kevlar, or other such suitable material. The flexure joint 40 may also be composed of a laminated structure comprising two or more layers of materials such as those listed above.

The flexure joint 40 may alternately be defined by a material property, the modulus of elasticity. The modulus of elasticity (Young's modulus) is a fundamental material constant, and is an index of the flexibility (or stiffness) of the material. For many common structural materials, the strain is an essentially linear function of the stress over the range of stresses normally encountered.

The modulus of elasticity, E, is given by the following equation:
E=Δσ/Δε,
where:
E =the modulus of elasticity (measured in units of force per unit area),
σ=stress (measured in units of force per unit area), and
ε=strain (a dimensionless ratio of length units, i.e., inches/inch).

The material that makes up the flexure joint 40 and its dimensions and shape are designed to provide the flexure joint 40 with a modulus of elasticity ranging from about 0.7 MPa to about 200 GPa, and more preferably from about 120 GPa to about 180 GPa.

FIG. 4 is a cross-sectional view of a flexure joint suspension system 82 according to an embodiment of the invention incorporating a metal flexure joint in a welded configuration, using conventional welding techniques. Each weld 72 performs the function of the bolt fasteners 70 in the suspension system 80 of FIG. 2.

FIG. 5 is a cross-sectional view of a flexure joint suspension 84 system according to an embodiment of the invention incorporating a single flexure joint 40 coupled to suspension arm 30 and a rotational-type pivot joint 86 coupling a second suspension arm 32. As would be understood by one having ordinary skill in the art, the single flexure joint 40 could be coupled to either the upper or lower suspension arm 30, 32 according to embodiments of the invention.

Thus, embodiments of the FLEXURE PIVOTS FOR RECREATIONAL VEHICLE SUSPENSION are disclosed. One skilled in the art will appreciate that the invention can be practiced with embodiments other than those disclosed. The disclosed embodiments are presented for purposes of illustration and not limitation, and the invention is limited only by the claims that follow.

1. A vehicle suspension comprising:
a first bracket adapted to be operatively coupled to a chassis;
a first suspension arm having a second bracket operatively coupled to one end thereof; and
a body formed of a piece of flexible material operatively coupling the first bracket with the second bracket operatively coupled to the one end of the suspension arm.

2. The vehicle suspension according to claim 1 further comprising a second suspension arm having a third bracket located at one end thereof.

3. The vehicle suspension according to claim 2 wherein the first and second suspension arms are coupled to the chassis in a generally vertical relationship to each other.

4. The vehicle suspension according to claim 3 wherein the second suspension arm is coupled to the chassis by a ball joint.

5. The vehicle suspension according to claim 1 wherein the body is composed of a single material.

6. The vehicle suspension according to claim 5 wherein the material is a metal.

7. The vehicle suspension according to claim 6 wherein the metal is steel.

8. The vehicle suspension, according to claim 1 wherein the body is composed of a composite material.

9. The vehicle suspension according to claim 8 wherein the composite material is selected from the group consisting of plastic, rubber, fiberglass, Kevlar, and carbon fiber.

10. The vehicle suspension according to claim 1 wherein the body is composed of a laminated structure comprising two or more layers.

11. The vehicle suspension according to claim 1 wherein the body has a modulus of elasticity ranging from about 0.70 MPa to about 200 GPa.

12. The vehicle suspension according to claim 11 wherein the body has a modulus of elasticity more preferably ranging from about 120 GPa to about 180 GPa.

13. The vehicle suspension according to claim 1 wherein the body has a thickness ranging from about 0.10 inches to about 2.5 inches.

14. The vehicle suspension according to claim 13 wherein the thickness of the body is varied over the length of the body.

15. The vehicle suspension according to claim 1 wherein the body has a length ranging from about 0.125 inches to about 24 inches.

16. The vehicle suspension according to claim 1 wherein the widest part of the body has a width ranging from about 0.10 inches to about 24 inches.

17. The vehicle suspension according to claim 16 wherein the width of the body is varied over the length of the body.

18. The vehicle suspension according to claim 1 wherein the body has a thickness ranging from about 0.10 inches to about 2.5 inches, a length ranging from about 0.125 inches to about 24 inches, and the widest part of the body has a width ranging from about 0.10 inches to about 24 inches.

19. The vehicle suspension according to claim 18 wherein the body has a thickness more preferably ranging from about 0.25 inches to about 0.5 inches, a length more preferably ranging from about 3.5 inches to about 6.0 inches, and the widest part of the body has a width more preferably ranging from about 2 inches to about 4 inches.

20. The vehicle suspension according to claim 1 wherein the body is adapted to break or tear during a suspension-damaging event.

21. The vehicle suspension according to claim 1 wherein the bracket located on the chassis is shaped to receive a first end of the body and the second bracket is shaped to receive an opposite end of the body.

22. The vehicle suspension according to claim 1 wherein the bracket located on the chassis has a recess for receiving a first end of the body and the second bracket has a recess for receiving an opposite end of the body.

23. The vehicle suspension according to claim 1 wherein the bracket located on the chassis, the second bracket located on the first suspension arm, and opposite ends of the body each have an aperture for receiving a bolt therethrough for coupling the body to the chassis and first suspension arm.

24. The vehicle suspension according to claim 1 wherein the bracket located on the chassis, the second bracket located on the first suspension arm, and opposite ends of the body each have a plurality of apertures for receiving bolts therethrough for coupling the body to the chassis and first suspension arm.

25. The vehicle suspension according to claim 1 wherein the bracket located on the chassis and the second bracket located on the first suspension arm each have a first arm and a second arm spaced apart from one another to define a recess therebetween which receives an end of the body.

26. A recreational vehicle comprising:
a chassis;
an engine;
a ground-engaging member;
a first bracket located on the chassis;
a first suspension arm having a second bracket located at one end thereof and operatively coupled to the ground-engaging member at an opposite end thereof; and
a body formed of a piece of flexible material operatively coupling the first bracket located on the chassis with the second bracket located at the one end of the suspension arm.

27. An All Terrain Vehicle (ATV) comprising:
a chassis;
an engine;
a ground-engaging member;
a first bracket located on the chassis;
a first suspension arm having a second bracket located at one end thereof and operatively coupled to the ground-engaging member at an opposite end thereof; and
a body formed of a piece of flexible material operatively coupling the first bracket located on the chassis with the second bracket located at the one end of the suspension arm.

28. An apparatus for joining an ATV suspension arm to an ATV chassis, the apparatus comprising:
a body of flexible material having a first end and a second end;
a first aperture located at the first end of the body of flexible material; and
a second aperture located at the second end of the body of flexible material.

29. The apparatus according to claim 28 further comprising two or more apertures at each of the first and second ends of the body of flexible material.

30. A method of coupling a suspension arm to the chassis of a recreational vehicle, the method comprising the steps of:
locating a bracket on the chassis;
locating a second bracket at one end of the suspension arm; and
operatively coupling the bracket located on the chassis with the bracket located at the one end of the suspension arm with a body formed of a flexible material.
